(19) United States
(12) Patent Application Publication
(10) Pub. No.: US 2025/0104930 A1
(43) Pub. Date: Mar. 27, 2025

(54) ELECTRODE FOIL FOR ELECTROLYTIC CAPACITOR, ELECTROLYTIC CAPACITOR, AND METHOD FOR MANUFACTURING ELECTRODE FOIL FOR ELECTROLYTIC CAPACITOR

(71) Applicant: Panasonic Intellectual Property Management Co., Ltd., Osaka (JP)

(72) Inventors: NAOMI KURIHARA, Osaka (JP); HIDEYUKI KURAHASHI, Tokyo (JP); MIWA OGAWA, Osaka (JP)

(21) Appl. No.: 18/687,354

(22) PCT Filed: Aug. 17, 2022
(86) PCT No.: PCT/JP2022/031066

§ 371 Date: Aug. 28, 2024

(30) Foreign Application Priority Data
Sep. 16, 2021 (JP) 2021-151278

(51) Int. Cl. H01G 9/055; H01G 9/045

(52) U.S. Cl. CPC H01G 9/055; H01G 9/045

(57) ABSTRACT

A porous portion and a core portion continuous with the porous portion are provided. In a thickness direction of the porous portion, when the porous portion is equally divided into first to tenth regions in order from an outer surface side of the porous portion, A1 to A10 μm/μm² respectively represent pit circumferential lengths of the first to tenth regions. At this time, a high-capacitance electrolytic capacitor is provided by using an electrode foil for an electrolytic capacitor in which a maximum value Aₘₐₓ of the pit circumferential lengths among A1 to A10, a (Nₘₐₓ)th region indicating Aₘₐₓ, a minimum value Aₘᵢₙ of the pit circumferential lengths among regions located at a side close to the outer surface of the porous portion with respect to the (Nₘₐₓ)th region, and a (Nₘᵢₙ)th region indicating Aₘᵢₙ satisfy a relationship of {(Aₘₐₓ/Aₘᵢₙ−1)×100}/(Nₘₐₓ−Nₘᵢₙ)≤6, 85≤Aₘₐₓ, and 2≤Nₘₐₓ.

### TECHNICAL FIELD

The present disclosure relates to an electrode foil for an electrolytic capacitor, an electrolytic capacitor, and a method for manufacturing an electrode foil for an electrolytic capacitor.

### BACKGROUND

For an anode body of an electrolytic capacitor, a metal foil containing a valve metal is used, for example. In order to increase the capacitance of the electrolytic capacitor, a main surface of the metal foil is etched to form a porous portion. Thereafter, a layer of a metal oxide (dielectric) is formed on a surface of the metal skeleton constituting the porous portion by performing an anodizing treatment on the metal foil.

PTL 1 proposes an electrolytic capacitor containing, in a capacitor element including an anode foil including an etching foil having a porosity of less than or equal to 51%, a bonded body in which a phosphoric acid ion is bonded to a water-soluble metal complex, and a solvent including water as a main component.

### CITATION LIST

### Patent Literature

PTL 1: Unexamined Japanese Patent Publication No. 2002-359165

### SUMMARY

An electrode foil for an electrolytic capacitor according to one aspect of the present disclosure includes a porous portion and a core portion continuous with the porous portion. When the porous portion is equally divided into first to tenth regions arranged in order from an outer surface side of the porous portion in a thickness direction of the porous portion, and A1 to A10 μm/μm² respectively represent pit circumferential lengths of the first to tenth regions, a maximum value Aₘₐₓ of the pit circumferential lengths among A1 to A10, a (Nₘₐₓ)th region indicating Aₘₐₓ, a minimum value Aₘᵢₙ of the pit circumferential lengths among regions located at a side close to the outer surface of the porous portion with respect to the (Nₘₐₓ)th region, and a (Nₘᵢₙ)th region indicating Aₘᵢₙ satisfy a relationship of {(Aₘₐₓ/Aₘᵢₙ−1)×100}/(Nₘₐₓ−Nₘᵢₙ)≤6, 85≤Aₘₐₓ, and 2≤Nₘₐₓ.

An electrolytic capacitor according to another aspect of the present disclosure includes the electrode foil for an electrolytic capacitor including a dielectric layer covering at least a part of a surface of a metal skeleton constituting the porous portion, and a cathode part covering at least a part of the dielectric layer.

A method for manufacturing an electrode foil for an electrolytic capacitor according to still another aspect of the present disclosure includes a first step of preparing a metal foil and a second step of roughening the metal foil to form a porous portion. The second step includes an etching step of etching the metal foil and an intermediate treatment step performed midway through the etching step. In the intermediate treatment step, a protective film is formed on a part of a surface of the metal foil by a gas phase method.

According to the present disclosure, a high-capacitance electrolytic capacitor can be obtained.

### BRIEF DESCRIPTION OF THE DRAWINGS

FIG. 1 is a schematic sectional view illustrating an electrode foil (anode body) according to one exemplary embodiment of the present disclosure.

FIG. 2 is a schematic sectional view illustrating an electrolytic capacitor according to an exemplary embodiment of the present disclosure.

FIG. 3 is a perspective view schematically illustrating a configuration of a wound body of FIG. 2.

### DESCRIPTION OF EMBODIMENT

Prior to the description of an exemplary embodiment, problems in the conventional technology are briefly described below.

Since etching proceeds from a surface of the metal foil to the inside, and dissolution easily proceeds on the surface of the metal foil, the surface area (pit circumferential length) tends to be small on the surface layer of the porous portion. Thus, it is still insufficient to increase the capacitance by increasing the surface area of the electrode foil.

In view of the above problem, the present disclosure provides an electrode foil for an electrolytic capacitor, an electrolytic capacitor, and a method for manufacturing an electrode foil for an electrolytic capacitor for providing a high-capacitance electrolytic capacitor.

Hereinafter, an electrode foil for an electrolytic capacitor before a dielectric layer is formed is also referred to as “first electrode foil” or “anode body”, and an electrode foil for an electrolytic capacitor having a dielectric layer is also referred to as “second electrode foil”.

### (First Electrode Foil)

An electrode foil for an electrolytic capacitor (first electrode foil) according to the present exemplary embodiment includes a porous portion and a core portion continuous with the porous portion. That is, the first electrode foil is an integrated product of the core portion and the porous portion. The first electrode foil is used as an anode body of an electrolytic capacitor. The metal part constituting the porous portion and the core portion contain a first metal.

The first electrode foil is obtained, for example, by roughening a metal foil by etching a part of the metal foil, the metal foil being formed of the first metal included in the metal part constituting the porous portion. The porous portion is a surface (outer) part of the metal foil that has been made porous through etching, and the remaining portion which is an inner portion of the metal foil is the core portion. The porous portion has pits (or pores) surrounded by the metal part containing the first metal.

In a thickness direction of the porous portion, the porous portion is equally divided into first to tenth regions in order from an outer surface side (a surface opposite to the core portion) of the porous portion (first electrode foil), and A1 to A10 (μm/μm²) respectively represent pit circumferential lengths of the first to tenth regions. At this time, maximum value Aₘₐₓ of the pit circumferential lengths among A1 to A10, a (Nₘₐₓ)th region indicating Aₘₐₓ, minimum value Aₘᵢₙ of the pit circumferential lengths among regions located at a side close to the outer surface of the porous portion with respect to the (Nₘₐₓ)th region, and a (Nₘᵢₙ)th region indicating Aₘᵢₙ satisfy the relationship of the following (i) to (iii).

$$( i ) \{ ( {A}_{max} / {A}_{min} - 1 ) \times 1 \; 00 \} / ( {N}_{max} - {N}_{min} ) \leq 6$$

$$( ii ) 85 \leq {A}_{max} , and$$

$$( iii ) 2 \leq {N}_{max}$$

When there are a plurality of regions indicating maximum value Aₘₐₓ of the pit circumferential lengths among A1 to A10, the region closest to the core portion among the plurality of regions is defined as Nₘₐₓ. When there are a plurality of regions indicating minimum value Aₘᵢₙ of the pit circumferential lengths in the region located at a side close to the outer surface of the porous portion with respect to the (Nₘₐₓ)th region, the region located closest to the outer surface of the porous portion among the plurality of regions is defined as Nₘᵢₙ. For example, when the pit circumferential lengths A1 to An of the first to n-th regions (n is more than or equal to 2) all indicate maximum value Aₘₐₓ, the n-th region is Nₘₐₓ, the first region is Nₘᵢₙ, and Aₘᵢₙ=Aₘₐₓ. In this case, the left member of Formula (i) is 0.

A1 to A10 may be expressed as relative values (hereinafter, also referred to as pit circumferential length indices L1 to L10) when Aₘᵢₙ is set to 100. In this case, for the above (i), it can be said that maximum value Lₘₐₓ of the pit circumferential length indices among L1 to L10, the (Nₘₐₓ)th region indicating Lₘₐₓ, minimum value Lₘᵢₙ of the pit circumferential length indices in the region located at a side close to the outer surface of the porous portion with respect to the (Nₘₐₓ)th region, and the (Nₘᵢₙ)th region indicating Lₘᵢₙ satisfy the relationship of (Lₘₐₓ−Lₘᵢₙ)/(Nₘₐₓ−Nₘᵢₙ)≤6. Note that Lₘᵢₙ=100.

The (Nₘₐₓ)th region is any one among a second to tenth regions. When the (Nₘₐₓ)th region is the second region, the (Nₘᵢₙ)th region is the first region. When the (Nₘₐₓ)th region is any one among a third to tenth regions, the (Nₘᵢₙ)th region is any one among the first to (Nₘₐₓ−1)th regions.

The “pit circumferential length” means the length of the contour of the region occupied by the pit in a section of the electrode foil (porous portion) in the thickness direction, and is expressed as the total length of the contours included per unit area of the section. The larger the pit circumferential length, the larger the surface area of the electrode foil surface. The pit circumferential length can be increased by forming a large number of pits with small diameters.

When the relationships (i) to (iii) are satisfied, Aₘₐₓ is large, the difference between Aₘₐₓ and Aₘᵢₙ (difference between Lₘₐₓ and Lₘᵢₙ) is small, and a large surface area per unit volume can be secured in the region (surface layer of the porous portion) located at a side close to the outer surface of the porous portion with respect to Nₘₐₓ. As a result, a high capacitance can be achieved. From the viewpoint of increasing the capacitance, (Lₘₐₓ−Lₘᵢₙ)/(Nₘₐₓ−Nₘᵢₙ) is preferably less than or equal to 3.

Thickness T of the porous portion may be more than or equal to 25 μm, or more than or equal to 40 μm, or may range from 25 μm to 160 μm, inclusive. By increasing the thickness of the porous portion while increasing the surface area per unit volume, it is possible to further increase the surface area (increase the capacitance).

In general, when thickness T of the porous portion is increased within the above range, the dissolution reaction easily proceeds in the surface layer of the porous portion due to the progress of etching, and thus the pit diameter tends to increase (the pit circumferential length tends to decrease). In particular, when thickness T of the porous portion is large, it is more difficult to increase the capacitance. On the other hand, for example, by performing an intermediate treatment step (formation of a protective film through an atomic layer deposition method) or the like in a midway through the etching step, which is described later, it is possible to effectively suppress a decrease in the pit circumferential length in the surface layer of the porous portion even when the porous portion with large thickness T is formed. Even in the porous portion having large thickness T, (Lₘₐₓ−Lₘᵢₙ)/(Nₘₐₓ−Nₘᵢₙ) can be reduced to less than or equal to 6 (or less than or equal to 3), and the effect of increasing the capacitance can be remarkably obtained.

Pit circumferential lengths A1 to A10 of the first to tenth regions can be obtained as follows.

(a) An image of a section of the first electrode foil (anode body) in the thickness direction is obtained using an electron microscope. A scanning electron microscope (SEM) or a transmission electron microscope (TEM) can be used as the electron microscope.

(b) Image processing is performed. First, filtering processing is performed to remove noise. Further, binarization processing is performed to distinguish between pits (voids) and a metal skeleton constituting the porous portion, and an edge of the metal skeleton (a contour of a region occupied by the pits) is extracted.

(c) In the section of the porous portion having thickness T (μm), a region having width T/10 extending in the thickness direction of the porous portion is freely selected. The region is equally divided into ten regions in the thickness direction of the porous portion, and the regions are defined as first to tenth regions in order from the outer surface of the porous portion (first electrode foil). That is, T/10×T/10 square sections (for example, area: 9 μm² to 64 μm²) arranged in a line in the thickness direction of the porous portion are set as the first region to tenth regions in order from the outer surface of the porous portion.

(d) The total length of the contours of the regions occupied by the pits included in the first region (T/10×T/10 square section) is obtained, and a value obtained by dividing the total length by the area of the section is obtained as pit circumferential length A1 of the first region. Pit circumferential lengths A2 to A10 of the second square section to tenth regions are also obtained in the same manner as in the case of A1. Further, A1 to A10 may be obtained as relative values when Aₘᵢₙ is set to 100, and may be set as pit circumferential length indices L1 to L10 of the first to tenth regions, respectively. For example, L2 is obtained from (A2/Aₘᵢₙ)×100.

From the viewpoint of increasing the capacitance, Aₘₐₓ/Aₘᵢₙ (Lₘₐₓ/Lₘᵢₙ) may range from 1 to 1.25, inclusive, and may be preferably close to 1 within the above range, and for example, may range preferably from 1 to 1.10, inclusive, and mat be more preferably 1. From the viewpoint of increasing the capacitance, Aₘₐₓ is more than or equal to 85 μm/μm², and may be more than or equal to 100 μm/μm². From the viewpoint of formation of a dielectric layer and impregnation of an electrolyte, Aₘₐₓ may be, for example, less than or equal to 160 μm/μm², or less than or equal to 150 μm/μm².

The (Nₘᵢₙ)th region is a region located at a side close to the outer surface of the porous portion with respect to the (Nₘₐₓ)th region. That is, Nₘᵢₙ<Nₘₐₓ. Nₘᵢₙ may range from 1 to 3, inclusive, or may be 1. That is, any one of L1 to L3 (or L1) may be Lₘᵢₙ. Nₘₐₓ may be more than or equal to 4, and may range from 4 to 6, inclusive. That is, any one of L4 to L10 (or L4 to L6) may be Lₘₐₓ. When Nₘₐₓ is in the above range, a region having a large surface area is likely to be formed in portions from the surface layer portion to the central portion of the porous portion, and thus the capacitance tends to increase.

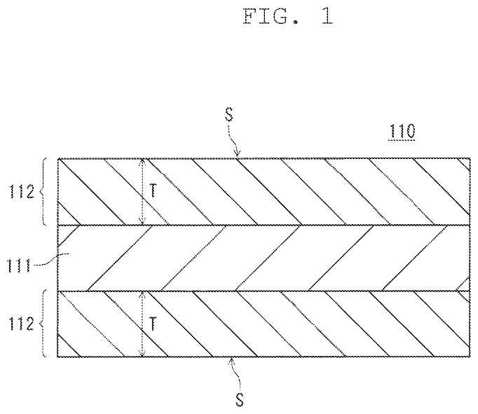

FIG. 1 is a schematic sectional view illustrating an anode body (first electrode foil) according to one exemplary embodiment of the present disclosure. Anode body 110 is an integrated product of core portion 111 and porous portion 112, and porous portion 112 has thickness T. Porous portion 112 can be equally divided into ten regions of a first to tenth regions each having thickness T/10 in order from an outer surface S (opposite side from core portion 111) of porous portion 112. Porous portion 112 is formed on both surfaces of anode body 110.

### (Second Electrode Foil)

The electrode foil for an electrolytic capacitor according to the present exemplary embodiment may be a second electrode foil including the first electrode foil (or an anode body) and a dielectric layer covering at least a part of a surface of a metal part (metal skeleton) constituting the porous portion of the first electrode foil. The configuration of the dielectric layer is not particularly limited.

In the second electrode foil, the thickness of the dielectric layer varies depending on the rated voltage of the electrolytic capacitor, but the dielectric layer has a thickness ranging from 4 nm to 300 nm, inclusive, and is formed relatively thin along the shape of the surface of the metal part. Thus, in a thickness direction of the porous portion of the second electrode foil, the porous portion is divided into ten equal regions of a first to tenth regions in order from the outer surface (a surface opposite to the core portion) of the porous portion (second electrode foil), the pit circumferential length indices of the first to tenth regions are defined as LD1 to LD10 (μm/μm²), the maximum value of the pit circumferential indices among LD1 to LD10 is defined as LDₘₐₓ, the region indicating LDₘₐₓ is defined as (NDₘₐₓ)th region, the minimum value of the pit perimeter indices in the region located at a side close to the outer surface of the porous portion with respect to the (NDₘₐₓ)th region is defined as LDₘᵢₙ, and a region indicating LDₘᵢₙ is defined as (NDₘᵢₙ)th region. In this case, NDₘₐₓ=Nₘₐₓ and NDₘᵢₙ=Nₘᵢₙ are satisfied, and (LDₘₐₓ−LDₘᵢₙ) is substantially equal to (Lₘₐₓ−Lₘᵢₙ). Therefore, when 2≤Nₘₐₓ and (Lₘₐₓ−Lₘᵢₙ)/(Nₘₐₓ−Nₘᵢₙ)≤6, 2≤LDₘₐₓ and (LDₘₐₓ−LDₘᵢₙ)/(NDₘₐₓ−NDₘᵢₙ)≤6 can be satisfied. LD1 to LD10 can be obtained in the same manner as in the case of L1 to L10.

Thickness T of the porous portion is not particularly limited, and may be appropriately selected according to the application of the electrolytic capacitor, a required withstand voltage and rated capacitance, and the like. The thickness T of the porous portion may be selected from, for example, a range from 10 μm to 160 μm, inclusive. Thickness T of the porous portion may range, for example, from 1/10 to 5/10, inclusive, of the thickness of the first electrode foil or the second electrode foil. The thickness T of the porous portion may be determined by cutting the first electrode foil or the second electrode foil so as to obtain a section in the thickness direction of the core portion and the porous portion, taking an electron micrograph of the section, and calculating an average value of thicknesses at any ten points of the porous portion.

The pit diameter peak of the pits (or the pore diameter peak of the pores) of the porous portion is not particularly limited, but may range, for example, from 50 nm to 2000 nm, inclusive, or from 100 nm to 300 nm, inclusive, from the viewpoint of increasing the surface area and forming the dielectric layer up to a deep portion of the porous portion. The peak of the pit diameter (pore diameter) is a most frequent pore diameter of a volume-based pore diameter distribution measured by, for example, a mercury porosimeter.

### (Dielectric Layer)

The dielectric layer is provided so as to cover at least a part of the surface of the metal part surrounding the pits (or pores). The dielectric layer may contain an oxide of the first metal contained in the metal part. The dielectric layer may have a first layer having thickness T1 containing an oxide of a second metal different from the first metal contained in the metal part. When the oxide of the second metal different from the first metal is added in the dielectric layer, for example, the second metal having a high dielectric constant can be selected without being restricted by the first metal. Thus, the capacitance of the electrolytic capacitor is easily improved. Since a range of selection of the second metal is widened, various performances can be imparted to the dielectric layer without being restricted by the first metal.

The withstand voltage of the electrolytic capacitor is not particularly limited, and for example, the electrolytic capacitor may have a relatively low withstand voltage of 1 V or more and less than 4 V, or may have a relatively high withstand voltage of more than or equal to 4 V, more than or equal to 15 V, or more than or equal to 100 V. When an electrolytic capacitor having a withstand voltage of more than or equal to 4 V is obtained, a thickness of the dielectric layer is preferably more than or equal to 4 nm. When an electrolytic capacitor having a withstand voltage of more than or equal to 15 V is obtained, a thickness of the dielectric layer is preferably more than or equal to 21 nm.

More specifically, for example, when an electrolytic capacitor having a large withstand voltage of more than or equal to 60 V is obtained, the pore diameter peak of the porous portion may range, for example, from 50 to 300 nm, inclusive, the thickness of the porous portion may range, for example, from 30 to 160 μm, inclusive, and the thickness of the dielectric layer may range, for example, from 30 to 100 nm, inclusive.

When an electrolytic capacitor having a relatively low withstand voltage of, for example, less than or equal to 10 V is obtained, the pore diameter peak of the porous portion may range, for example, from 20 to 200 nm, inclusive, the thickness of the porous portion may range, for example, from 30 to 160 μm, inclusive, and the thickness of the dielectric layer may range, for example, from 4 to 30 nm, inclusive.

### (Method for Manufacturing Electrode Foil)

A method for manufacturing an electrode foil for an electrolytic capacitor according to the present exemplary embodiment includes, for example, a first step of preparing a metal foil and a second step of roughening the metal foil to form a porous portion. The first electrode foil is obtained by the second step.

### (First Step)

The metal foil prepared in the first step contains the first metal. The type of the first metal is not particularly limited, but a valve metal such as aluminum (Al), tantalum (Ta), or niobium (Nb) or an alloy containing a valve metal may be used from the viewpoint of easily forming a dielectric layer or a second layer through anodization. The thickness of the metal foil is not particularly limited, and ranges, for example, from 15 μm to 300 μm, inclusive.

### (Second Step)

### (Etching Step)

The second step includes an etching step of etching the metal foil. Roughening through etching causes the porous portion having a plurality of pits (or pores) to form in the surface part of the metal foil. At the same time, the core portion integrated with the porous portion is formed in the inner part of the metal foil. The etching is performed by, for example, direct current etching using direct current or alternating current etching using alternating current.

The etching step may be performed in a plurality of steps, or a plurality of etching tanks for holding an etching solution may be disposed. The etching solution contains, for example, hydrochloric acid as a main component. The pit circumferential length can be controlled, for example, by appropriately adjusting an etching current (current density, frequency), an etching solution (concentration, temperature), an etching time, and the like. The etching current and the like may be changed according to the step. The etching current and the like may be changed continuously or stepwise. For example, as the frequency is lower, the starting point where the pit is formed tends to move to a deeper portion of the electrode foil. The lower the current density and the lower the etching solution temperature, the finer the pit shape tends to become. In addition, the number of steps (the number of etching tanks to be disposed) may be appropriately adjusted.

### (Intermediate Treatment Step)

The second step further includes an intermediate treatment step performed in a midway through the etching step. The intermediate treatment step is performed by temporarily interrupting etching in a midway through the etching step. In the intermediate treatment step, a protective film is formed on a part of the surface of the metal foil in a midway through etching. Specifically, the pit wall surface is covered with the protective film to a predetermined depth of the porous region on the metal foil surface in a midway through etching, and the pit wall surface in the deep portion of the porous region is not covered with the protective film. As a result, in the part covered with the protective film, growth of pits (enlargement of a pit diameter) can be suppressed, and in the part not covered with the protective film in the deep portion of the porous region, pits can be grown with the part as a starting point.

Appropriately performing the intermediate treatment step in a midway through the etching step can makes it possible to grow pits while adjusting the pit diameter. This can effectively control the pit circumferential length and can effectively suppress enlargement of the pit diameter (reduction of the pit circumferential length) due to the progress of the dissolution reaction in the surface layer of the porous portion accompanying the progress of etching. That is, the difference between Aₘₐₓ and Aₘᵢₙ can be reduced.

Thickness T of the porous portion may be more than or equal to 25 μm, or may be more than or equal to 40 μm. In this case, with the progress of etching, the dissolution reaction proceeds in the surface layer of the porous portion, and the pit diameter tends to be enlarged. Thus, by adopting the intermediate treatment step (in particular, a step of forming a protective film through a gas phase method described later), the effect of suppressing the enlargement of the pit diameter in the surface layer (reduction of the pit circumferential length) is remarkably obtained. By adopting the intermediate treatment step (in particular, the step of forming a protective film through a gas phase method described later), the first electrode foil according to the present disclosure is likely to be obtained.

The intermediate treatment step may be performed a plurality of times at a predetermined timing in a midway through the etching step. The protective film may be formed stepwise while enlarging the porous region in the depth direction with the progress of etching. The number of times and timing of performing the intermediate treatment step may be appropriately adjusted to adjust the pit circumferential length. In the case of forming a protective film through a gas phase method described later, the pit circumferential length may be adjusted by appropriately adjusting the supply amount of the source gas (oxidant gas) into the reaction chamber, the temperature in the reaction chamber, and the diffusion time of the source gas (oxidant gas) in the reaction chamber. In the case of forming a protective film through immersion in an acid treatment liquid described later, the pit circumferential length may be adjusted by appropriately adjusting the acid treatment solution (temperature, concentration) and the immersion time.

The intermediate treatment step may be a step of forming a protective film on a part of the surface of the metal foil in the middle of etching through a gas phase method. As the gas phase method, for example, a vacuum vapor deposition method, a chemical vapor deposition method, a mist vapor deposition method, a sputtering method, a pulsed laser deposition method, an atomic layer deposition method (ALD method), and the like may be exemplified. Of these, the ALD method is preferable. In the gas phase method (in particular, ALD method), the protective film can be stably formed as compared with the method through immersion in an acid treatment solution described later, and the thickness of the protective film and the film formation depth in the porous region (region in the deep portion of the porous region where the film is not formed) can be easily controlled. The degree of suppressing pit growth can be adjusted with the thickness of the protective film. A region where pit growth is suppressed can be adjusted with the film formation depth in the porous region. In the method for forming a protective film through immersion in an acid treatment solution described later, it is difficult to control the thickness and the film formation depth of the protective film, and it is difficult to stably form the protective film.

For example, in the film formation step through the ALD method, the thickness of the protective film can be easily controlled with the number of cycles. Further, in the film formation step, the film formation depth in the porous region of the metal foil in the middle of etching can be controlled with the diffusion time and partial pressure of the source gas and the oxidant in the reaction chamber. The diffusion time of the raw material gas (oxidant) in the reaction chamber is a time from when the source gas (oxidant) is supplied into the reaction chamber to when the source gas is exhausted to the outside of the reaction chamber in one cycle to be described later. The partial pressure is the pressure of the source gas (oxidant) in the reaction chamber.

The ALD method is a film formation method in which a predetermined film is formed on the surface of an object by alternately supplying a source gas and an oxidant to a reaction chamber in which the object is disposed. In the ALD method, a self-limiting action functions, and thus, the metal contained in the source gas is deposited on the surface of the object in atomic layer units. Thus, the thickness of the film can be easily controlled with the number of cycles in which supply of raw material gas, exhaust (purge) of raw material gas, supply of oxidant, and exhaust (purge) of oxidant are taken as one cycle.

The source gas is supplied to the reaction chamber as a gas of a precursor. The precursor may contain the first metal. When the first metal contained in the metal foil prepared in the first step is Al, a precursor containing Al may be selected, and examples thereof include trimethylaluminum ((CH₃)₃Al). Examples of the oxidant include water, oxygen, and ozone. The oxidant may be supplied to the reaction chamber as an oxidant-based plasma.

The intermediate treatment step may be a step of immersing the metal foil in the middle of etching in an acid treatment solution (for example, an aqueous sodium phosphate solution) containing a phosphorus compound. For example, the film formation depth in the porous region of the metal foil in the middle of etching can be controlled with the acid treatment solution (temperature, concentration) and the immersion time.

In the second step, for example, formation of the porous portion is performed by electrolytic etching in which a plurality of etching tanks are disposed, and formation of the protective film is performed using a film formation apparatus through a gas phase method (ALD method or the like). In this case, from the viewpoint of improving productivity, the second step may be performed by a roll-to-roll method. In this case, the ALD treatment may be performed in a vacuum or in an inert gas atmosphere under atmospheric pressure. The metal foil after the intermediate treatment may be wound once, and then the etching treatment may be performed again. In addition, the metal foil may be wound once in a midway through etching, then subjected to the intermediate treatment, wound, and then subjected to an etching treatment again. The protective film may be formed by disposing an immersion tank that holds the acid treatment solution.

The method for manufacturing an electrode foil for an electrolytic capacitor according to the present exemplary embodiment may further include a third step of forming a dielectric layer covering at least a part of the surface of the metal skeleton constituting the porous portion of the first electrode foil. The third step provides the second electrode foil.

The step of forming the dielectric layer may be, for example, a step of subjecting the anode body (first electrode foil) to an anodizing treatment (anodizing). For example, a voltage is applied to the first electrode foil in a state of being immersed in an anodizing solution such as an ammonium adipate solution, an ammonium phosphate solution, or an ammonium borate solution, whereby the second electrode foil in which the dielectric layer is formed on the surface of the metal portion is obtained.

The step of forming the dielectric layer may be a step of depositing an oxide of a second metal different from the first metal contained in the metal part on the surface of the metal portion through a gas phase method to form a first layer having thickness T1. This makes it possible to obtain the second electrode foil in which the dielectric layer is formed on the surface of the metal part.

### (Electrolytic Capacitor)

An electrolytic capacitor according to the present exemplary embodiment includes the second electrode foil and a cathode part covering at least a part of the dielectric layer of the second electrode foil. The cathode part may include an electrolyte. The electrolyte covers at least a part of the dielectric layer.

The electrolyte contains at least one of a solid electrolyte and an electrolytic solution. The cathode part may contain a solid electrolyte and an electrolytic solution, and may contain a solid electrolyte and a non-aqueous solvent. Hereinafter, the electrolytic solution and the non-aqueous solvent are also collectively referred to as “liquid component”. The covering of the dielectric layer with the solid electrolyte (or electrolytic solution) is performed, for example, by impregnating the second electrode foil (or wound body) with a treatment solution (or electrolytic solution) containing a conductive polymer. The treatment solution may contain a non-aqueous solvent.

The solid electrolyte contains a conductive polymer. Examples of the conductive polymer include a π-conjugated polymer. Examples of the conductive polymer include polypyrrole, polythiophene, polyfuran, and polyaniline. The conductive polymer may be used alone, may be used in combination of two or more thereof, or may be a copolymer of two or more monomers. The weight-average molecular weight of the conductive polymer ranges, for example, from 1,000 to 100,000, inclusive.

In the present specification, polypyrrole, polythiophene, polyfuran, polyaniline, and the like mean polymers respectively having polypyrrole, polythiophene, polyfuran, polyaniline, and the like as a basic skeleton. Polypyrrole, polythiophene, polyfuran, polyaniline, and the like therefore may also include derivatives thereof. For example, polythiophene includes poly(3,4-ethylenedioxythiophene).

The conductive polymer may be doped with a dopant. The solid electrolyte may contain a dopant together with the conductive polymer. Examples of the dopant include polystyrenesulfonic acid. The solid electrolyte may further contain an additive agent as necessary.

The liquid component is in contact with the dielectric layer directly or via the conductive polymer. The liquid component may be a non-aqueous solvent or an electrolytic solution. The electrolytic solution contains a non-aqueous solvent and an ionic substance (solute (for example, organic salt)) dissolved in the non-aqueous solvent. The non-aqueous solvent may be an organic solvent or an ionic liquid.

Preferably, the non-aqueous solvent is a high-boiling-point solvent. For example, a polyol compound such as ethylene glycol, a sulfone compound such as sulfolane, a lactone compound such as γ-butyrolactone, an ester compound such as methyl acetate, a carbonate compound such as propylene carbonate, an ether compound such as 1,4-dioxane, a ketone compound such as methyl ethyl ketone, and the like can be used.

The liquid component may contain an acid component (anion) and a base component (cation). A salt (solute) may be formed from the acid component and the base component. The acid component contributes to the film restoration function. Examples of the acid component include organic carboxylic acids and inorganic acids. Examples of the inorganic acid include phosphoric acid, boric acid, and sulfuric acid. Examples of the base component include primary to tertiary amine compounds.

The organic salt is a salt in which at least one of an anion and a cation contains an organic substance. As the organic salt, for example, trimethylamine maleate, triethylamine borodisalicylate, ethyldimethylamine phthalate, mono-1,2,3,4-tetramethylimidazolinium phthalate, mono-1,3-dimethyl-2-ethyl imidazolinium phthalate, and the like may be used.

From the viewpoint of suppressing dedoping of the dopant from the conductive polymer (deterioration of the solid electrolyte), the liquid component preferably contains an acid component more than the base component. In addition, since the acid component contributes to the film restoration function of the liquid component, it is preferable that the acid component contains a larger amount of the acid component than the base component. The molar ratio of the acid component to the base component: (acid component/base component) is, for example, more than or equal to 1.1. From the viewpoint of suppressing dedoping of the dopant from the conductive polymer, the pH of the liquid component may be less than or equal to 6, or may range from 1 to 5, inclusive.

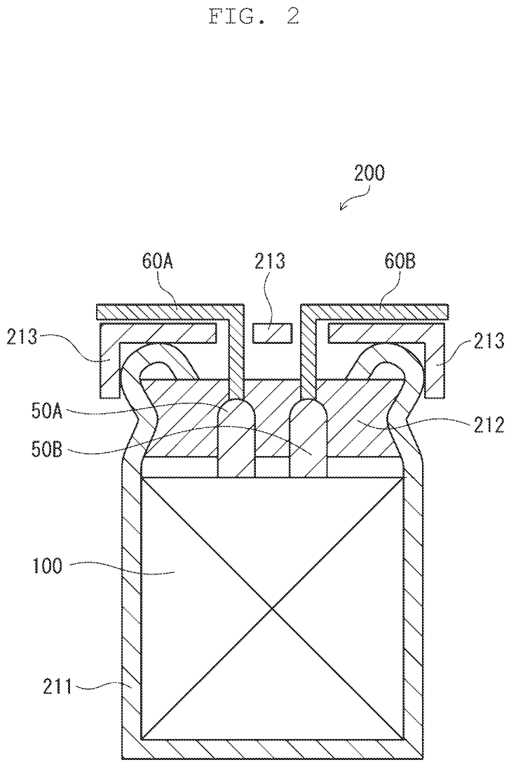

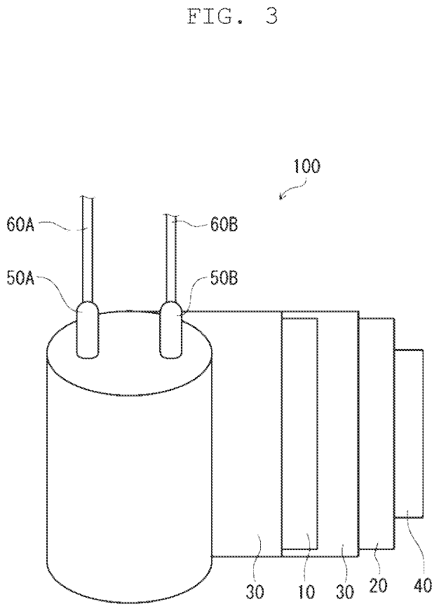

Here, FIG. 2 is a sectional view schematically illustrating an electrolytic capacitor according to one exemplary embodiment of the present invention. FIG. 2 illustrates an example of an electrolytic capacitor including a wound-type capacitor element. FIG. 3 is a perspective view schematically illustrating a configuration of a wound body of FIG. 2.

Electrolytic capacitor 200 includes wound body 100. Wound body 100 is formed by winding anode foil 10 and cathode foil 20 with separator 30 interposed therebetween. Separator 30 is not particularly limited. For example, an unwoven fabric including fibers of cellulose, polyethylene terephthalate, vinylon, or polyamide (for example, aliphatic polyamide or aromatic polyamide such as aramid) or the like may be used.

End portions on one side of lead tabs 50A and 50B are connected to anode foil 10 and cathode foil 20, respectively, and wound body 100 is formed while lead tabs 50A and 50B are wound. Lead wires 60A and 60B are connected to end portions on the other side of lead tabs 50A and 50B, respectively.

Winding stop tape 40 is disposed on an outer surface of cathode foil 20 positioned at an outermost layer of wound body 100, and an end portion of cathode foil 20 is fixed by winding stop tape 40. When anode foil 10 is prepared by cutting a large foil, an anodizing treatment may further be performed on wound body 100 in order to provide a dielectric layer on a cutting surface.

Wound body 100 contains an electrolyte, and the electrolyte is interposed between anode foil 10 (dielectric layer) and the cathode foil. Wound body 100 containing an electrolyte may be performed, for example, by impregnating wound body 100 with a treatment solution (or an electrolytic solution) containing a conductive polymer. The impregnation may be performed under a reduced pressure, for example, in an atmosphere of 10 kPa to 100 kPa.

Wound body 100 is housed in bottomed case 211 such that lead wires 60A, 60B are positioned on an opening side of bottomed case 211. As a material of bottomed case 211, a metal such as aluminum, stainless steel, copper, iron, or brass, or an alloy thereof may be used.

Sealing member 212 is disposed at an opening portion of bottomed case 211 in which wound body 100 is housed, an opening end of bottomed case 211 is caulked to sealing member 212 to be curled, and base plate 213 is disposed at a curled portion. Thus, wound body 100 is sealed in bottomed case 211.

Lead wires 60A, 60B penetrate sealing member 212. Sealing member 212 is an insulating substance, and is preferably an elastic body. In particular, silicone rubber, fluororubber, ethylene propylene rubber, Hypalon rubber, butyl rubber, isoprene rubber, or the like, having high heat resistance, is preferable.

In the above exemplary embodiment, a wound-type electrolytic capacitor has been described, but the application range of the present invention is not limited thereto, and the present invention can also be applied to other electrolytic capacitors, for example, stacked-type electrolytic capacitors. A stacked-type electrolytic capacitor includes, for example, a stacked-type capacitor element and an exterior body that seals the capacitor element. A stacked-type capacitor element includes an anode body, a solid electrolyte layer, and a cathode lead-out layer covering the solid electrolyte layer. The anode body includes the electrode foil (first electrode foil) having a porous portion formed on a part of the surface thereof, and a dielectric layer covering a metal skeleton constituting the porous portion of the electrode foil. The solid electrolyte layer is formed so as to cover the dielectric layer. The cathode lead-out layer includes, for example, a silver paste layer and a carbon layer. An anode lead is connected to a region of the anode body that is not covered with the dielectric layer, and a cathode lead is connected to the cathode lead-out layer. A part of each of the anode lead and the cathode lead is exposed from the exterior body. A plurality of capacitor elements may be stacked to form a stacked body.

Hereinafter, the present disclosure will be described in more detail based on Examples, but the present disclosure is not limited to Examples.

### Examples 1 to 3 and Comparative Example 1

### (Production of First Electrode Foil)

An Al foil (thickness: 100 μm) was prepared as a metal foil (first step). An etching step of etching the Al foil was performed, and an intermediate treatment step was further performed in a midway through the etching step to obtain a first electrode foil having a porous portion on both surfaces of the Al foil (second step).

The etching step was performed as follows.

The Al foil was pretreated with an aqueous hydrochloric acid solution, and then electrolytic etching was performed by applying an alternating current in an etching solution containing hydrochloric acid as a main component. In the etching step, the number of steps (the number of etching tanks to be disposed), an etching current (current density, frequency), an etching solution temperature, and an etching time were appropriately adjusted. In Example 1 and Comparative Example 1, the etching current (current density, frequency) and the etching solution (temperature, concentration) were appropriately changed in three stages according to the progress of etching. In Examples 2 to 3, the etching current (current density, frequency) and the etching solution (temperature, concentration) were appropriately changed in six stages according to the progress of etching.

The intermediate treatment step was performed as follows.

In Example 1, as the intermediate treatment step, a protective film was formed on a part of the surface of the Al foil through a gas phase method. Specifically, an oxide containing Al was formed as a protective film by an ALD method (temperature: 200° C., precursor: trimethylaluminum (Al(CH₃)₃, TMA), oxidant: H₂O, pressure: 10 Pa, 20 cycles). The number and timing of performing the intermediate treatment step were appropriately adjusted. In one cycle, the diffusion time of the precursor (source gas) and the oxidant in the reaction chamber were appropriately adjusted.

In Examples 2 to 3 and Comparative Example 1, as the intermediate treatment step, the Al foil was immersed in a sodium phosphate aqueous solution (temperature: 70° C., concentration: 15 mass %) to form a protective film on a part of the surface of the Al foil. The immersion time at this time was appropriately adjusted. The number and timing of performing the intermediate treatment step were appropriately adjusted. In Example 2, the immersion condition was appropriately changed for each intermediate treatment step. In Example 3 and Comparative Example 1, the immersion conditions were constant in each intermediate treatment step.

In this manner, a porous portion having pit circumferential lengths A1 to A10 of values shown in Table 1 was formed on both surfaces of the Al foil to obtain a first electrode foil. The pit circumferential lengths A1 to A10 shown in Table 1 were obtained by the method described above. In X1-1 to X1-3, Al was Aₘᵢₙ, and was more than or equal to 100 μm/μm². Table 2 shows pit circumferential length indices L1 to L10 obtained from A1 to A10. Table 3 shows Lₘₐₓ, Nₘₐₓ, Lₘᵢₙ, Nₘᵢₙ, and (Lₘₐₓ−Lₘᵢₙ)/(Nₘₐₓ−Nₘᵢₙ). In Tables 1 to 3, X1-1 to X3-1 are the first electrode foil of Examples 1 to 3, and Y1-1 is the first electrode foil of Comparative Example 1.

TABLE 1

| | Pit circumferential length | | | | | | | | | |
|---|---|---|---|---|---|---|---|---|---|---|
| | (μm/μm²) | | | | | | | | | |
| First | First | Second | Third | Fourth | Fifth | Sixth | Seventh | Eighth | Nineth | Tenth |
| electrode | region | region | region | region | region | region | region | region | region | region |
| foil | (A1) | (A2) | (A3) | (A4) | (A5) | (A6) | (A7) | (A8) | (A9) | (A10) |
| X1-1 | 128 | 133 | 136 | 139 | 140 | 132 | 125 | 112 | 101 | 93 |
| X2-1 | 147 | 150 | 151 | 153 | 148 | 142 | 126 | 117 | 108 | 91 |
| X3-1 | 128 | 134.9 | 134.5 | 134.0 | 133 | 129 | 124 | 108 | 100 | 90 |
| Y1-1 | 109 | 123 | 132 | 138 | 141 | 131 | 124 | 108 | 100 | 90 |

TABLE 2

| | Pit circumferential length index | | | | | | | | | |
|---|---|---|---|---|---|---|---|---|---|---|
| First | First | Second | Third | Fourth | Fifth | Sixth | Seventh | Eighth | Nineth | Tenth |
| electrode | region | region | region | region | region | region | region | region | region | region |
| foil | (L1) | (L2) | (L3) | (L4) | (L5) | (L6) | (L7) | (L8) | (L9) | (L10) |
| X1-1 | 100 | 103.9 | 106.3 | 108.6 | 109.4 | 103.1 | 97.7 | 87.5 | 78.9 | 72.7 |
| X2-1 | 100 | 102.0 | 102.7 | 104.1 | 100.7 | 96.6 | 85.7 | 79.6 | 73.5 | 61.9 |
| X3-1 | 100 | 105.4 | 105.1 | 104.7 | 103.9 | 100.8 | 96.9 | 84.4 | 78.1 | 70.3 |
| Y1-1 | 100 | 112.8 | 121.1 | 126.6 | 129.4 | 120.2 | 113.8 | 99.1 | 91.7 | 82.6 |

TABLE 3

| First | | | | | (Lₘₐₓ − Lₘᵢₙ)/ |
|---|---|---|---|---|---|
| electrode foil | Lₘₐₓ | Nₘₐₓ | Lₘᵢₙ | Nₘᵢₙ | (Nₘₐₓ − Nₘᵢₙ) |
| X1-1 | 109.4 | 5 | 100 | 1 | 2.34 |
| X2-1 | 104.1 | 4 | 100 | 1 | 1.36 |
| X3-1 | 105.4 | 2 | 100 | 1 | 5.40 |
| Y1-1 | 129.4 | 5 | 100 | 1 | 7.34 |

### (Production of Second Electrode Foil)

The first electrode foil was subjected to an anodizing treatment to obtain a second electrode foil. Specifically, the first electrode foil was immersed in a diammonium adipate aqueous solution (ammonium adipate concentration: 10 mass %), a direct current was applied to the first electrode foil, and after a formation voltage reached about 35 V, the first electrode foil was held for about 10 minutes, washed with water, and then heated in air at 300° C. for 5 minutes. Thereafter, the obtained second electrode foil was cut into a predetermined shape. X1-2 to X3-2 are the second electrode foil of Examples 1 to 3, and Y1-2 is the second electrode foil of Comparative Example 1.

Electrostatic capacity (frequency: 120 Hz) of the second electrode foil obtained above was measured in an ammonium adipate aqueous solution (concentration: 15 mass %) at 30° C. Table 4 shows the evaluation results. The electrostatic capacity in Table 4 is expressed as a relative value when the measured value of Y1-2 (second electrode foil) of Comparative Example 1 is 100.

TABLE 4

| Second | Electrostatic |
|---|---|
| electrode | capacity |
| foil | (relative value) |
| X1-2 | 108 |
| X2-2 | 122 |
| X3-2 | 104 |
| Y1-2 | 100 |

As shown in Table 4, in X1-2 to X3-2, a higher capacity was obtained than in Y1-2.

### INDUSTRIAL APPLICABILITY

The electrode foil for an electrolytic capacitor according to the present disclosure is suitably used for an electrolytic capacitor requiring a large capacitance.

### REFERENCE MARKS IN THE DRAWINGS

10: anode foil
20: cathode foil
30: separator
40: winding stop tape
50A, 50B: lead tab
60A, 60B: lead wire
100: wound body
110: anode body
111: core portion
112: porous portion
200: electrolytic capacitor
211: bottomed case
212: sealing member
213: base plate

1. An electrode foil for an electrolytic capacitor, the electrode foil comprising:
a porous portion; and
a core portion continuous with the porous portion, wherein:
when the porous portion is equally divided into first to tenth regions arranged in order from an outer surface side of the porous portion in a thickness direction of the porous portion, and A1 to A10 μm/μm² respectively represent pit circumferential lengths of the first to tenth regions,
a maximum value Aₘₐₓ of the pit circumferential lengths among A1 to A10, a (Nₘₐₓ)th region indicating Aₘₐₓ, a minimum value Aₘᵢₙ of the pit circumferential lengths among regions located at a side close to the outer surface of the porous portion with respect to the (Nₘₐₓ)th region, and a (Nₘᵢₙ)th region indicating Aₘᵢₙ satisfy a relationship of {(Aₘₐₓ/Aₘᵢₙ−1)×100}/(Nₘₐₓ−Nₘᵢₙ)≤6, 85≤Aₘₐₓ, and 2≤Nₘₐₓ.

2. The electrode foil for an electrolytic capacitor according to claim 1, wherein {(Aₘₐₓ/Aₘᵢₙ−1)×100}/(Nₘₐₓ−Nₘᵢₙ)≤3 is satisfied.

3. The electrode foil for an electrolytic capacitor according to claim 1 or 2, wherein 4≤Nₘₐₓ is satisfied.

4. The electrode foil for an electrolytic capacitor according to any one of claims 1 to 3, wherein a thickness T of the porous portion is more than or equal to 25 μm.

5. The electrode foil for an electrolytic capacitor according to any one of claims 1 to 4, the electrode foil further comprising a dielectric layer covering at least a part of a surface of a metal skeleton constituting the porous portion.

6. An electrolytic capacitor comprising:
the electrode foil for an electrolytic capacitor according to claim 5; and
a cathode part covering at least a part of the dielectric layer.

7. The electrolytic capacitor according to claim 6, wherein the cathode part includes an electrolyte.

8. The electrolytic capacitor according to claim 6, wherein the cathode part includes a solid electrolyte.

9. A method for manufacturing an electrode foil for an electrolytic capacitor, the method comprising:
a first step of preparing a metal foil; and
a second step of roughening the metal foil to form a porous portion, wherein:
the second step includes:
an etching step of etching the metal foil; and
an intermediate treatment step performed midway through the etching step, and
in the intermediate treatment step, a protective film is formed on a part of a surface of the metal foil by a gas phase method.

10. The method for manufacturing an electrode foil for an electrolytic capacitor according to claim 9, wherein in the intermediate treatment step, the protective film is formed by an atomic layer deposition method.
